(19) United States
(12) Patent Application Publication
(10) Pub. No.: US 2005/0106363 A1
(43) Pub. Date: May 19, 2005

(54) Coupon verification methods and systems

(75) Inventors: Bruce D. Williams, Round Lake, IL (US); Scott Goldstein, Highland Park, IL (US); Richard W. Johnston, Fort Erie (CA)

Correspondence Address: BRINKS HOFER GILSON & LIONE, P.O. BOX 10395, CHICAGO, IL, 60610, US

(73) Assignee: Leo Burnett USA, Inc.

(21) Appl. No.: 10/713,169

(22) Filed: Nov. 13, 2003

(51) Int. Cl. B41M 3/00

(52) U.S. Cl. 428/195.1

(57) ABSTRACT

Using printing and coating of non-currency grade paper, authentication of coupons or other documents is provided for minimal cost. By coating the document with a UV/EB material having a desired trace chemical residual content (e.g., substantially no starch), the authenticity of a coupon or document is checked using already widely distributed counterfeit currency detection pens. Since many retail establishments rely on iodine or potassium permanganate solution testing of currency, by providing a coating that reacts differently than non-currency grade paper, the same solution is used to verify the authenticity of coupons or other documents without the costs of using currency grade paper. The results of the test for authenticity are easily visible, allowing a coupon issuer to reimburse retail establishments only for coupons or documents that have been verified and shown to be authentic. By refusing to redeem or reimburse for untested or counterfeit coupons, losses due to counterfeiting may be reduced.

### BACKGROUND

The present invention relates to document verification. In particular, verification of the authenticity of documents may avoid monetary loses due to counterfeiting or fraud.

Various paper documents are associated with monetary values. For example, paper currency has a face value established by the government. Bank notes or checks represent monetary value. Yet another example is coupons. To induce consumers to purchase products, companies provide coupons representing a discount or monetary value. The coupons are redeemed at retail establishments, and the retail establishments are reimbursed by the company responsible for the coupon. However, counterfeiting results in a substantial loss of money. Reimbursing a retail establishment for accepting a counterfeit coupon may result in losses of money without a corresponding purchase of product or services.

To prevent losses due to counterfeiting, security devices are placed on various documents. For example, bank notes, bonds, stocks, checks and currency include coating or other devices that cannot be easily copied by a counterfeiter. These security devices are overt or covert. For example, holograms, color shifting laminations, swirl printing, foiling, and water marks printed on a document provide overt security by being difficult to copy. As another example, thermocromatic inks, monochromatic inks, ultraviolet florescent ink, and infrared reactive inks printed on a document provide covert security. Heat or light at particular frequencies shows the existence of the inks and authenticity of the document. More valuable documents, such as bank notes and currency, typically use overt systems, such as multi-layered color shifting or holograms.

U.S. Pat. No. 5,063,163 discloses one example form of security for currency. Currency is printed on high quality expensive paper. Starch, other iodine salts and other trace chemical residuals from the paper making process are removed from this grade of paper. As a result, an iodine or potassium permanganate based solution has a different reaction with currency paper or high grade paper than with non-currency or standard paper. The currency is marked with a pen having a chemical solution. If the paper has no or little starch, iodine salt or other trace chemical residue content, the solution maintains its color as a clear, yellow, orange, or a lighter shade color. If the paper contains starch, other iodine salts or trace chemical residue, a reaction occurs with the solution resulting in a dark, black, brown or different color. The reaction indicates counterfeit currency.

Documents representing a lesser value, such as coupons, may use lower cost covert systems, such as chemically sensitive inks (e.g. invisible ink). The cost of producing documents with security devices is much higher than the cost of producing documents without security devices. With sophisticated laser jet printing and highly accurate color copying widely available, the cost of producing security devices that are not easily duplicated by a counterfeiter is increasing. Security devices requiring tightly-controlled components or equipment-intensive processes are not practical for more cost effective documents, such as coupons or stamps. Since coupons may be used at various locations outside of a coupon issuer's control, complex verification processes are unlikely to be successful. The many locations for accepting coupons makes electronic and other specialized verification systems cost prohibitive. Accordingly, coupons, stamps, and other low value documents typically include minimal or no security devices.

### BRIEF SUMMARY

Using printing and coating of non-currency grade paper, authentication of coupons or other documents is provided for minimal cost. By coating the document with a material having a desired starch content (e.g., a coating with a lack of starch), the authenticity of a coupon or document is checked using already widely distributed counterfeit currency detection pens. Since many retail establishments rely on iodine or other chemical solution testing of currency, by providing a coating with different starch content than is provided in non-currency grade paper, the same solution is used to verify the authenticity of coupons or other documents without the costs of using currency grade paper. For example, the coated area blocks the chemicals in the pen from reacting to impurities in non-currency grade paper. The results of the test for authenticity are easily visible, allowing a coupon issuer to reimburse retail establishments only for coupons or documents that have been verified and shown to be authentic. By refusing to redeem or reimburse for untested or counterfeit coupons, losses due to counterfeiting may be reduced.

Various aspects of the preferred embodiments may be used alone or in combination. In a first aspect, an improvement in a coupon printed on non-currency grade paper is provided for authenticated redemption at retail stores. The improvement includes a patterned coating having a starch content different than non-currency grade paper. The starch content of the non-currency grade paper is operative to react with a chemical solution such that the chemical solution changes color differently in response to contact with the non-currency grade paper than in response to contact with the patterned coating. For example, a lack of starch content has no or minimal reaction as compared to the non-currency grade paper.

In a second aspect, a coupon authentication system is provided for avoiding counterfeit coupon redemption. A coupon is provided for use with the purchase of a product or service from a retail store. A coating on the coupon has a lower amount of a trace chemical residual than the coupon. The coating is operable to provide a first mark as a function of the lower amount of trace chemical residual in response to a chemical where the mark is different than if the chemical were applied to the coupon without the coating.

In a third aspect, a method for manufacturing coupons that can be authenticated is provided. Material substantially free of a trace chemical residual is added to a printed coupon. The material substantially free of the trace chemical residual is operative to avoid reaction with a chemical such that the coupon changes color differently in response to contact with the printed coupon than in response to contact with the printed coupon having the added material substantially free of the trace chemical residual.

In a fourth aspect, a method for verifying the authenticity of the coupon is provided. A first material is provided on or within the coupon. A chemical is applied to the coupon. The coupon is determined to be authentic by a color that is responsive to the contact of the chemical with the material.

The present invention is defined by the following claims, and nothing in this section should be taking as a limitation on those claims. The above summary section is providing by way of introduction to the preferred embodiments described below. Further aspects and advantages of the invention are discussed below in conjunction with the preferred embodiments.

### BRIEF DESCRIPTION OF THE DRAWINGS

The figures are not necessarily to scale; instead, emphasis is placed upon illustrating the principles of the invention. Moreover, in the figures, like reference numerals designate corresponding parts throughout the different views.

FIG. 1 is a graphical representation of a coupon with a security device in one embodiment;

FIGS. 2-4 are graphical representations of coupons representing possible reactions of the coupon of FIG. 1 to application of a chemical or other test in various embodiments; and

FIG. 5 is a flow chart diagram of a method for verifying the authenticity of a coupon.

### DETAILED DESCRIPTION OF THE DRAWINGS AND PRESENTLY PREFERRED EMBODIMENTS

Coupons or other documents printed on non-currency grade, standard or lower grade paper are adapted to emulate currency grade paper with respect to an iodine, potassium permanganate or other chemical solution test. Since currency authentication is common in retail establishments that also accept coupons, minimal or no distribution of testing devices and education of clerks is required. Documents coated with material having a higher or a lower trace chemical residue (e.g., starch) content than the paper used for the coupon are difficult to counterfeit but use processes and equipment commonly available in place in commercial printing establishments.

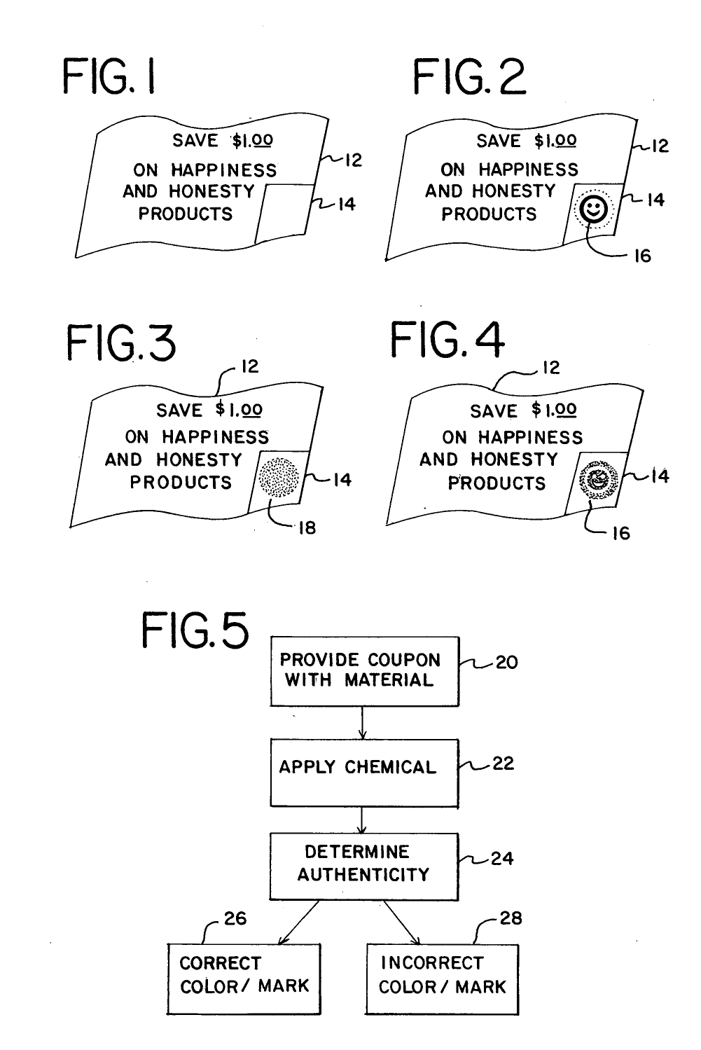

A coupon authentication system is provided for avoiding counterfeit coupon redemption. The system includes a coupon 12 as shown in FIG. 1. The coupon 12 is for use with the purchase of a product or a service from a retail store. Mail-in coupons or coupons for other uses may also be provided. In one embodiment, the coupon represents a discount value off of a product or service, but coupons representing a free product or service, a randomized prize or other redeemable value may be used.

The coupon 12 is printed on non-currency grade paper. For example, glossy paper used in a magazine, mailer, or newspaper insert is used. As another example, non-glossy paper, such as used in a newspaper or mailer is used. Non-currency grade papers include trace chemical residuals, such as starch, from the paper making process. In an alternative embodiment, the coupon is printed on currency grade paper. Any of various now known or later developed papers may be used. In yet another alternative embodiment, the coupon 12 is printed on plastic or other non-wood fiber materials.

The coupon 12 is improved for authenticated redemption by a coating. Any of various chemicals that react differently with any material in the coating than with non-currency grade paper or the coupon may be used. In one embodiment, the coating is substantially free of starch, other iodine salts and/or other trace chemical residues. The lack of trace chemical residue of the coating reacts with the chemical testing solution differently than the coupon paper. The chemical testing solution changes color differently in response to contact with non-currency grade paper than in response to contact with the coating. For example, the coating includes lower or no starch content than non-currency grade paper. The lower or no starch content leaves a white, clear, yellow, orange or lighter color in response to contact with an iodine or potassium permanganate solution, and a black, brown, or dark color is left in response to contact with the higher starch content of the non-currency grade paper. In alternative embodiments, a higher trace chemical residue content of the coating provides for a darker color than a lighter color resulting from the testing chemical solution contacting the non-currency grade paper or coupon. The coating has a different, such as higher, lesser or no, trace chemical residual content than the coupon or non-currency grade paper. Only one or a plurality of different trace chemical residuals are different in the coating than in the coupon or non-currency grade paper. No or some trace chemical residuals may have similar amounts of content in both the coating and the coupon or non-currency grade paper.

In one embodiment, the coating is Miracure® LB101, 102, or 103 from Sovereign Speciality Chemicals of Buffalo, N.Y. This is an ultraviolet curable coating with excellent hold-out on paper stock and provides a fast curing, mid-range viscosity, clear cured film with high chemical resistance having a viscosity at 77° F., LVF#2 at 6 RPM of 170-220 CPS, a Zhan #3 in seconds at 25° C. of 20-25, a weight per gallon in lbs at 77° F. of 9.0-9.2, a percent reactive of 100% with antifoam and wetting agents, and a cured optimization of about 120 mJ at approximately 95 fmp/300 watt/inch lamp. In an alternative embodiment, the viscosity is about 2200 CPS with a weight per gallon of about 9.34 or 9.18 lbs in a cure optimization of 150 mJ or a per gallon of 9.18. These coatings have a high cross-link density and reological characteristics to avoid penetrating and rest over the coupon during and after application. The coating provides a barrier over the coupon paper. Coatings with other, additional or different properties may be used.

The coating is cured by ultraviolet or electron beam radiation, but other curing techniques for the coating may be used. The coating is capable of being applied over standard inks and standard, non-currency grade paper. In one embodiment, the dried coating accepts and maintains standard printing inks for printing the coupon on top of the coating. Rheology allowing patterning of the coating is provided in one embodiment, but a coating meant for general application without patterning may be used. In one embodiment, the coating has sufficient chemical resistance to resist solvent solutions used as carriers in iodine, potassium permanganate or other chemical testing solutions, such as disclosed in U.S. Pat. Nos. 5,063,163 and 5,393,556, the disclosures of which are incorporated herein by reference. The coating has sufficient viscosity to encapsulate the paper and paper fibers to isolate the chemical reaction between a chemical and a coating as opposed to the chemical and the paper. The coating is adapted to emulate the texture, feel and reflectivity of the coupon. In one embodiment, the coating with different characteristics than the coupon may be used. Coatings from other manufactures may also be used. The different (e.g., substantially no) trace chemical residue (e.g., starch) content of the coating is operable to result in a first mark in response to a chemical that is different than if the chemical were applied to the coupon without the coating.

In one embodiment, the coating is applied over an entire surface of the coupon 12. Application over less than the entire coupon 12, such as over 80%, may be used. In an alternative embodiment, the coating is applied in a pattern on the coupon. For example, the coating is applied over a region, such as the region 14, of the coupon 12 in any of the various shapes or sizes. As yet another example, the coating is patterned in a logo pattern. The logo represents a trademark or other indication of product, service or company. FIG. 2 shows a happy face logo 16 patterned within the region 14 of the coupon 12. In other embodiments, the pattern is applied randomly or in a repeated pattern on one or both sides of the coupon 12. Any of various patterns may be used without a specific region or in a specific region.

To manufacture the coupon, a printed coupon is provided using either a sheet fed or web fed printing process. The coating, such as a UV/EB coating, is added to the printed coupon. Alternatively, the coating is added to the coupon paper prior to printing of the coupon. In one embodiment, the coating is added using a flexo process. For example, a rubber plate on a rotary device places the coating on the paper. The paper and applied coating are then dried, such as by using ultraviolet or electron beam curing. Other now known or later developed drying processes may be used. In one embodiment, a glue unit or a coater unit are used for a flexo process. Where a patterned coating is provided, the rubber plate of the flexo device is patterned using photo exposure or other now known or later developed techniques. A blanket coating may also be used, such as for applying the coating without patterning in a flexo device. In an alternative embodiment, the coating is applied with an ink fountain, such as a lithography tower or ink roller. One or more of the ink fountains in a lithography printing press applies the coating in a pattern or uniform sheet. Either of an oil- or a water-based ink fountain may be used. To avoid decreasing the number of colors or inks available for use in printing a coupon, the flexo device is used. In yet other alternative embodiments, intaglio with etched plates is used for applying the coating or printing rather than the emulsion provided by the lithography device. Other now known or later developed processes and devices for applying ink or coatings may be used in either of web or sheet fed printing presses. In an alternative embodiment, the coupon 12 is impregnated with the material.

The coupon 12 is manufactured using standard printing ink, a normal printing process, and non-currency grade paper with standard coating devices followed by standard curing equipment. For example, any of the coupons discussed above may be used, such as a coupon coated with a UV/EB coating on non-currency grade paper or patterned material on a coupon. The resulting coupon 12 interacts with a counterfeit currency detection solution, such as an iodine, potassium permanganate or other standard solution, already in use by retailers. As a result, a coupon with a security device to prevent counterfeiting is provided with minimal increased cost.

FIG. 5 shows a method for verifying the authenticity of a coupon. In act 20, a first material is provided on or within a coupon. For example, any of the coupons discussed above may be used, such a coupon coated with a material having a lower trace chemical residual content (e.g., no starch content) than non-currency grade paper or a patterned material on a coupon.

In act 22, a chemical is applied to the coupon. For example, an iodine solution, potassium permanganate solution, counterfeit money detection solution, or other now known or later developed chemical is applied to the coupon. The chemical is applied to the coupon in a verification area, such as the region 14 shown in FIGS. 1-4, or in any other location on the coupon 12. For example, the coupon 12 is marked with a currency counterfeit detection pen. As a result of the contact, the solution is applied to the coating or material.

In act 24, the authenticity of the coupon is determined. A color responsive to the contact of the chemical with the material, such as iodine or potassium permanganate solution with the coating, indicates the authenticity. The color of an area marked by application of the chemical is compared with a predetermined standard. If the starch or other trace chemical residue content of the coating or material is lower than the paper used for the coupon 12, the area of application of the chemical substantially maintains an initial color of the chemical to indicate an authentic coupon. Changing from the initial lighter coloration to a black or darker coloration indicates a counterfeit coupon. In alternative embodiments, a dark mark or changing from an initial color indicates a coupon is authentic, such as where the material or coating has a higher trace chemical residue content than the paper of the coupon. In such an embodiment, a light mark indicates a counterfeit coupon.

FIG. 3 shows an embodiment where an even or unpatterned coating of material with a lower or no trace chemical residual content, such as starch, than the remainder of the coupon 12 is applied in the region 14. The lightly brown area 18 represents application of a counterfeit money detection solution, such as an iodine solution, on the coating in the region 14. Since the material has a lower trace chemical residual content, the lighter area 18 represents an authentic coupon of act 26. Where the material or coating has higher trace chemical residual content, the application of the chemical to the coupon 12 of FIG. 1 resulting in a lighter area indicates a counterfeit coupon of act 28. For this higher trace chemical residual coating alternative, if, after application, the coupon of FIG. 1 changes to a darker color than the chemical as initially applied, the coupon 12 is considered an authentic coupon of act 26.

FIG. 2 represents application of the chemical to the region 14 were the material has been applied in a pattern or logo 16. The coupon 12 has the initial look of FIG. 1 and the look of FIG. 2 after the application of the chemical to the region 14 where the coupon is authentic as represented by act 26. In FIG. 2, the logo 16 represents a coating applied in a happy face pattern or represents the coating applied to the entire region and not applied to a happy face shaped area within the region 14. FIG. 4 represents an inverse application of the material or the coating of FIG. 2.

Various applications of the chemical may be used, including a single line, circular marking or other application. The coupon 12 is authentic if the encoded area of a logo turns brown or grey while the coated area remains clear or yellow or vice versa. The difference in color is easy to see and appears immediately after application of the chemical. The coating has a chemical resistance and hold-out to prevent the solution from the currency pen from contacting the paper surface. Accordingly, the currency detection pen or chemical solution is used to detect or verify the authenticity without the additional cost of currency grade paper stock.

The value of the coupon is redeemed at a retail store. A mark on the coupon 12 indicates application of the chemical. The coupon is redeemed if the coupon is shown to be authentic. Redemption of the value of the coupon is otherwise avoided. Retail stores are more likely to assure that coupon authenticity is verified when providing discounts to customers. When a coupon is not authentic, the customer will not receive a discount and the company responsible for coupon redemption will avoid having to reimburse counterfeit coupons. Since the verification process may result in visible marking of the coupon, the coupon is shown to be both authentic as well as previously verified by the retailer. Counterfeit coupons are less likely to be introduced by consumers or during transition from the retail store to the source of the coupons. The source of coupons may avoid redeeming the value to a retailer where the coupon is not marked or is not authentic.

While the invention has been described above reference to various embodiments, it should be understood that many changes and modifications can be made without departing from the scope of the invention. For example, coating with any of various compositions with or without starch, other iodine salts or other trace chemical residuals may be used on or within the coupon 12. As another example, any of various now known or later developed chemicals with or without iodine may be used for verifying the authenticity of the coupon. In yet other embodiments, the security device described herein is used on non-currency grade documents other than coupons or even on currency grade documents.

It is therefore intended that the foregoing detailed description be regarding as illustrative rather than limiting, and that it be understood that it is the following claims, including all equivalents, that are intended to define the spirit and the scope of the invention.

1. An improvement in a coupon printed on non-currency grade paper for authenticated redemption at a retail store, the improvement comprising:
a coating having a trace chemical residual content different than the non-currency grade paper, the trace chemical residual content operative to react with a chemical solution such that the chemical solution changes color differently in response to contact with the non-currency grade paper than in response to contact with the coating.

2. The improvement of claim 1 wherein the coating comprises a logo pattern representative of at least one of: a product, a service and a company.

3. The improvement of claim 1 wherein the coating comprises a lesser starch content than the non-currency grade paper.

4. The improvement of claim 3 wherein the lesser starch content of the coating is operable to leave a lighter color in response to contact with the chemical solution comprising one of an iodine and a potassium permanganate solution, and the non-currency grade paper is operable to leave a darker color in response to contact with the chemical solution.

5. The improvement of claim 1 wherein the coating has a substantially no starch content.

6. A printed document for avoiding counterfeit coupon redemption, the system comprising:
a coupon for use with the purchase of a product or service from a retail store;
a coating on the coupon, the coating having a lower trace chemical residual content than the coupon and operable to provide a first mark as a function of the lower trace chemical residual content in response to a chemical, the mark being different than if the chemical is applied to the coupon without the coating.

7. The document of claim 6 wherein the coating encapsulates the coupon.

8. The document of claim 6 wherein the coating is patterned.

9. The document of claim 6 wherein the coupon comprises non-currency grade paper.

10. The document of claim 6 wherein the chemical comprises at least one of: iodine and potassium permanganate.

11. A method for verifying the authenticity of a coupon, the method comprising:
(a) providing a first material on or within the coupon;
(b) applying a chemical to the coupon; and
(c) determining that the coupon is authentic by a color responsive to a contact of the chemical with the material.

12. The method of claim 11 wherein (a) comprises coating the coupon with the first material, the first material having a lower starch content than non-currency grade paper.

13. The method of claim 11 wherein (a) comprises patterning the first material on the coupon.

14. The method of claim 11 wherein (b) comprises applying a chemical solution to at least the first material, the first material having a lower trace chemical residual content than non-currency grade paper.

15. The method of claim 11 wherein (b) comprises marking on the coupon with a currency counterfeit detection pen.

16. The method of claim 11 wherein (c) comprises comparing the color of an area marked in (b) with a predetermined standard whereby the area corresponds to a location of the first material and the area substantially maintains a color due to avoiding a reaction with a trace chemical residual in an authentic coupon and changes from an initial color to a darker coloration in a counterfeit coupon.

17. The method of claim 11 wherein (c) comprises determining that the coupon is authentic when a light mark results from (b) and not authentic when a dark mark results from (b).

18. The method of claim 11 wherein (a) comprises applying a coating having substantially no trace chemical residual on the coupon.

19. The method of claim 11 further comprising:
(d) redeeming a value of the coupon to a retail store where a mark indicates application of (b) and the coupon is authentic as determined in (c); and
(e) otherwise avoiding redemption of the value to the retail store.

20. A method for manufacturing coupons that can be authenticated, the method comprising:
(a) printing a coupon; and
(b) adding a material substantially free of trace chemical residuals to the coupon, the coupon operative to react with a chemical such that the coupon changes color differently in response to contact with the printed coupon free of the added material than in response to contact with the printed coupon having the added material.

21. The method of claim 20 wherein (b) comprises coating the printed coupon with the material substantially free of starch.

22. The method of claim 21 wherein (b) comprises coating with the material in a pattern.

23. The method of claim 20 wherein (a) comprises one of: sheet feed and web feed printing of the printed coupon on non-currency grade paper.

24. The method of claim 21 wherein (b) comprises coating the printed coupon with a flexo device.
